(19) United States
(12) Patent Application Publication
(10) Pub. No.: US 2007/0263876 A1
(43) Pub. Date: Nov. 15, 2007

(54) In-memory compression and encryption

(75) Inventors: Michael Jan De Waal, Osgoode (CA); Yufeng Chen, Gloucester (CA)

Correspondence Address: CASSAN MACLEAN, 307 GILMOUR STREET, OTTAWA, ON, K2P 0P7, CA

(73) Assignee: Global IQX, Inc.

(21) Appl. No.: 11/431,701

(22) Filed: May 11, 2006

(51) Int. Cl. H04L 9/00

(52) U.S. Cl. 380/286

(57) ABSTRACT

Methods and devices related to compression and encryption of data. Data to be encrypted and compressed is first received and then stored in physical memory. Once stored in a data structure in physical memory, the data is streamed to a process which compresses the data. The compressed data is then streamed, from the physical memory, to an encryption process. The compressed and encrypted data can then be transmitted. To decrypt and decompress, the compressed and encrypted data is first read into another data structure that stores the data into physical memory. The data is then streamed from the physical memory to, in turn, a decryption process and then a decompression process.

### FIELD OF THE INVENTION

The present invention relates to software based data compression and/or encryption. More specifically, the present invention relates to methods and devices related to in-memory data compression and/or encryption.

### BACKGROUND OF THE INVENTION

There has been an increasing need for faster and more secure data connections between businesses since the telecommunications explosion of the late 20^{th} century. More and more businesses require that their clients and suppliers connect to their internal networks and to send them invoices, orders, and other data electronically. Unfortunately, for some applications and for some businesses, such an approach requires lengthy transmission times for the data. Not only that, but, for some applications, the data being transmitted is sensitive. As such, the data must be encrypted.

To shorten the transmission times for the data, the data may be compressed in addition to being encrypted. Unfortunately, the combination of compressing the data and encrypting the data may lead to longer processing times, in addition to the requisite transmission time for the compressed and encrypted data. Not only that, but once the data has been received, it has to be correspondingly decrypted and decompressed at the receiving end, further increasing the time required for the whole process.

Based on the above, there is therefore a need for methods and devices for accelerating the processing of data prior to its transmission to a destination. Ideally, such a solution should be applicable regardless of the compression method used or the encryption method used. Furthermore, such a solution should, ideally, be implementable in software across different hardware and software platforms. Finally, it would also be preferable if the same solution could be applicable to the destination or receiving machine to further accelerate the process.

### SUMMARY OF THE INVENTION

The present invention provides methods and devices related to compression and encryption of data. Data to be encrypted and compressed is first received and then stored in physical memory. Once stored in a data structure in physical memory, the data is streamed to a process which compresses the data. The compressed data is then streamed, from the physical memory, to an encryption process. The compressed and encrypted data can then be transmitted. To decrypt and decompress, the compressed and encrypted data is first read into another data structure that stores the data into physical memory. The data is then streamed from the physical memory to, in turn, a decryption process and then a decompression process.

In a first aspect, the present invention provides a method for compressing data in a data processing machine having a physical memory, the method comprising:
a) reading data to be compressed into a data structure such that said data is stored in said physical memory;
b) executing a compression process on said machine for compressing the data;
c) streaming said data in said physical memory to said compression process; and
d) outputting compressed data from said compression process.

In a second aspect, the present invention provides A method for decompressing compressed data in a data processing machine having a physical memory, the method comprising:
a) reading compressed data to be decompressed into a data structure such that said compressed data is stored in said physical memory;
b) executing a decompression process on said machine, said decompression process being for decompressing said compressed data;
c) streaming said compressed data in said physical memory to said decompression process; and
d) outputting decompressed data from said decompression process.

In a third aspect, the present invention a method for processing data in a data processing machine having a physical memory, the method comprising:
a) receiving data for processing;
b) storing said data in a data structure such that said data is stored in said physical memory;
c) executing a process on said machine for processing said data;
d) streaming said data from said physical memory to said process initiated in step c); and
e) outputting processed data from said process.

### BRIEF DESCRIPTION OF THE DRAWINGS

A better understanding of the invention will be obtained by considering the detailed description below, with reference to the following drawings in which:

FIG. 1 illustrates a communications system between computers according to the prior art;

FIG. 2 is a flow diagram of the data flow for a source machine according to one aspect of the invention;

FIG. 3 illustrates a data flow between physical memory and a compression process according to another aspect of the invention;

FIG. 4 illustrates a data flow between physical memory and an encryption process according to another aspect of the invention;

FIG. 5 illustrates a data flow for a destination machine according to another aspect of the invention;

FIG. 6 illustrates a data flow between memory and two different processes for a destination machine;

FIG. 7 illustrates a flowchart for a source machine according to an aspect of the invention; and

FIG. 8 illustrates a flowchart for a destination machine according to another aspect of the invention.

### DETAILED DESCRIPTION

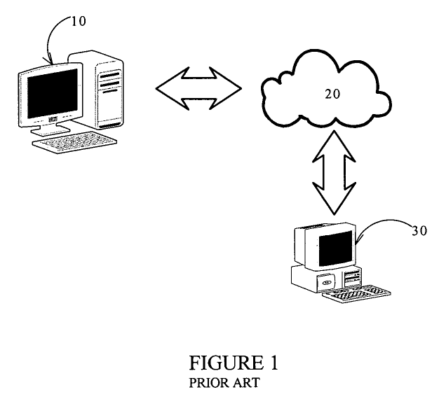

Referring to FIG. 1, a well-known system for communicating between computers is illustrated. A first computer (or data processing machine) 10 sends and receives data via a network 20 to a second computer 30. The second computer 30 similarly sends and receives data to the first computer 10 via the network 20 as well. To reduce the transmission time of data transmitting through the network 20, the data is preferably compressed. For security, the data, whether compressed or not, is preferably encrypted. Such encryption and/or compression is accomplished at the source machine and the accompanying decryption and/or decompression is accomplished at the destination machine.

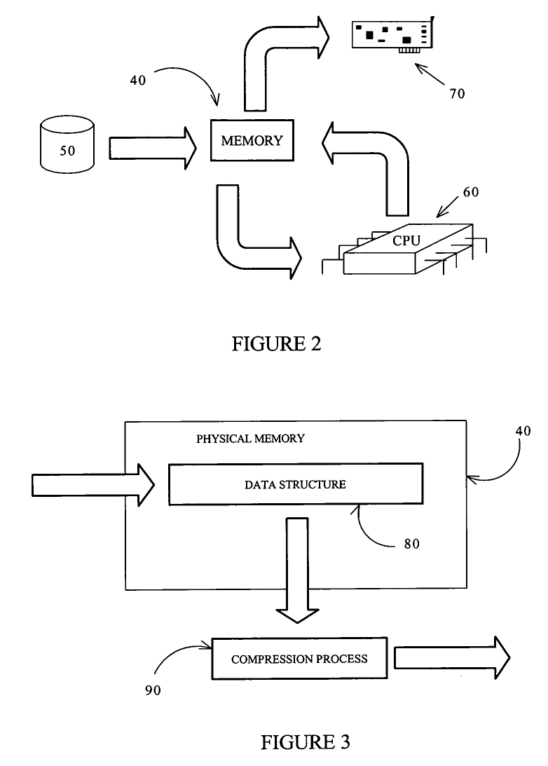

As noted above, compression and/or encryption is done at the source data processing machine. Referring to FIG. 2, a schematic diagram of how this may be done is illustrated. The data to be processed prior to transmission is sent to a physical memory 40 (such as random access memory or RAM of a computer) from, in this example, a disk storage device 50. If there is enough physical memory, it is preferable if all that data to be processed is completely stored in the physical memory. If there is insufficient physical memory, discrete portions of the data may be stored in the physical memory with succeeding portions being stored in turn. If such an option is to be employed, the data may be divided into equal predetermined amounts to assist in the storage. Once stored in physical memory, the data can be streamed to a process executed by a central processing unit (CPU) 60. The result of the processing is then written back to the physical memory either for further processing or for forwarding to the network interface 70.

As can be seen in FIG. 3, the data to be processed is first stored in a data structure 80 within the physical memory 40. The data structure may be a byte array, a bit array, or any other suitable data structure which can store the data in the physical memory and which can stream the data to a process being executed in the CPU 60. It is to be noted that while the data structure is represented as one block in FIG. 3, multiple data structures may be employred in the same physical memory to store the data. Once the data is stored in the physical memory, it is then streamed to a compression process 90 ( such as that executed by the GZIP compression utility). The output of this compression process may then be sent to the network interface for transmission to the destination machine or back to the physical memory for further processing. Other compression processes other than GZIP may, of course, be used.

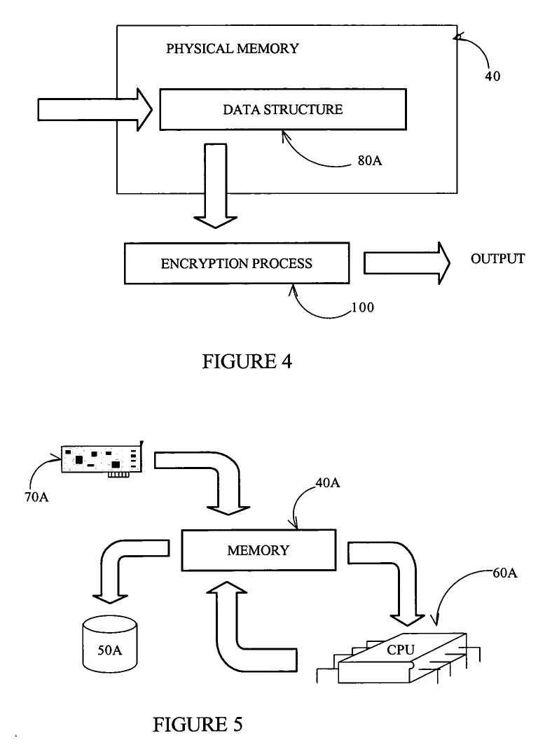

Referring to FIG. 4, such further processing may take the form of encrypting the compressed data. It should be noted, however, that the data to be encrypted need not be compressed data. The data to be encrypted is stored in a data structure 80A (which may be the same data structure 80 used in FIG. 3) in the physical memory 40 and is then streamed to an encryption process 100. One example of such an encryption process is that executed when software using the freely available Blowfish encryption algorithm is run. Other encryption processes may, of course, be used. The output of this encryption process 100 may then be sent to the network interface 70 (either coupled to or acting as an output port of the source machine) for transmission to the destination machine.

At the destination machine, a process that is the reverse of that in FIG. 2 is executed. This process is shown in FIG. 5. The network interface 70A in the destination machine (either by way of an input port or with the interface acting as the input port) receives the encrypted and/or compressed data for processing. Such data is then stored, again preferably completely, in the physical memory 40A of the destination machine. The stored data is then streamed to the CPU 60A of the destination machine for either decompression or decryption. Once the data has been processed, the processed data is sent back to the physical memory 40A for either further processing or for forwarding to storage 50A.

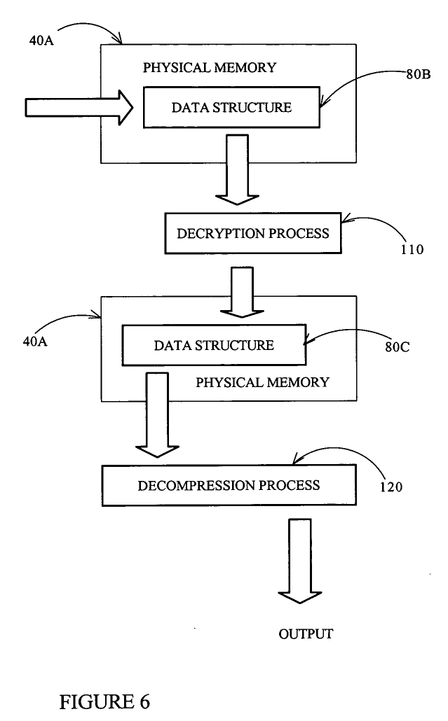

Referring to FIG. 6, the decryption and decompression processes are illustrated schematically. The encrypted and compressed data is first stored in the data structure 80B within the physical memory 40A. This is then streamed to the decryption process 110. The decryption process 110 has to be compatible with the encryption process used on the encrypted data, otherwise the data cannot be properly decrypted. Similarly, if passwords or encryption keys were used by the encryption process, the decryption process must be equipped with the corresponding passwords or decryption keys for a proper decryption of the encrypted data.

Once the encrypted data has been decrypted, the decrypted data is again stored in the physical memory 40A of the destination machine. The decrypted data is stored in a data structure 80C which may be the same as the data structure 80B used to store the encrypted and compressed data. It should be noted that the data structure used to store the encrypted and/or compressed data may be of the same type as that used to store the data prior to encryption or compression. It should further be noted that multiple data structures may be used simultaneously to completely store the data in the physical memory.

Once the decrypted data has been stored in the physical memory 40A of the destination machine, it is then streamed to a decompression process 120. The decompression process 120 is executed by the CPU 60A of the destination machine and is the complement to the compression process used on the data at the source machine. If the GZIP compression utility is used at the source machine, the UNGZIP decompression utility would be the preferred decompression process. The decompression process will therefore decompress the compressed data and then output the decompressed data for either storage to disk or for use by an end user.

In terms of implementation, a Java implementation has been found to be preferable due to the portability of the Java platform. Furthermore, well-known libraries for encryption and compression (as well as decryption and decompression) are readily available for the Java platform.

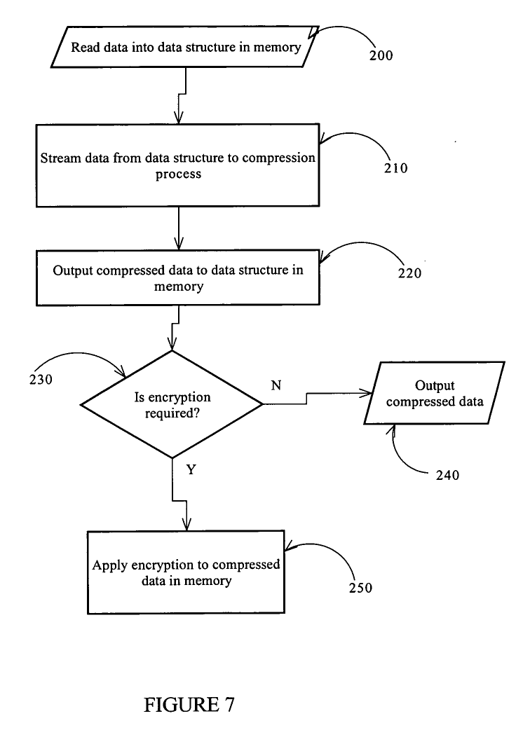

Referring to FIG. 7, a flowchart for the method for the source machine is illustrated. The first step in the method is that of receiving the data and reading the data into a data construct in the physical memory (step 200). The data is then streamed from the data construct to a compression process being executed on the machine (step 210). The now compressed data is then output to either another data construct or the same data construct in the physical memory (step 220). A decision 230 determines if further processing is required. IF the data does not need further processing, then it is output for transmission to a destination machine (step 240). On the other hand, if further processing is required, then the compressed data is sent to another process so that encryption may be applied (step 250). For the encryption process, the method is the same as that illustrated in FIG. 7 with the exception that an encryption process is used in step 210 as opposed to a compression process.

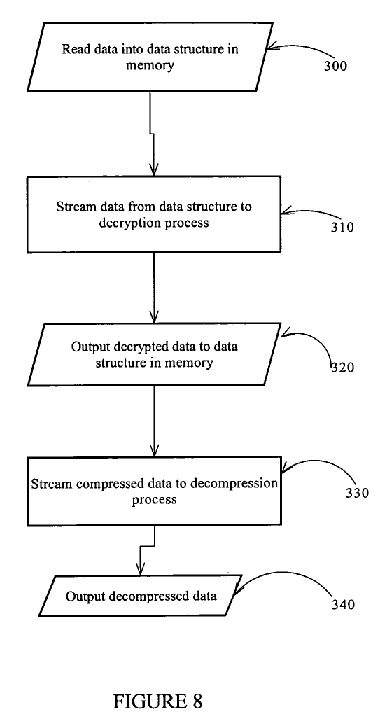

Referring to FIG. 8, a method for the destination machine is illustrated. For this method, the initial step is that of receiving the data and reading it into a data structure in the physical memory (step 300). The encrypted data is then streamed to a decryption process (step 310) running on the destination machine. The decrypted data is then output back to a data structure in the physical memory (step 320). The decrypted data is then streamed from physical memory to a decompression process (step 330). The decrypted and decompressed data is then output to the end user or to storage (step 340). IT should be noted that if the data received in step 300 is not encrypted, then the compressed data may be streamed directly to the decompression process. This is shown by the flow arrow from step 300 direct to step 330.

Embodiments of the invention may be implemented in any conventional computer programming language. For example, preferred embodiments may be implemented in a procedural programming language (e.g. “C”) or an object oriented language (e.g. “C++”). As noted above, the Java platform may be used to implement embodiments of the invention. Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for compressing data in a data processing machine having a physical memory, the method comprising:
a) reading data to be compressed into at least one data structure such that said data is stored in said physical memory;
b) executing a compression process on said machine for compressing the data;
c) streaming said data in said physical memory to said compression process; and
d) outputting compressed data from said compression process.

2. A method according to claim 1 wherein said data is completely stored in said physical memory prior to executing step b)

3. A method according to claim 1 wherein said at least one data structure is a byte array.

4. A method according to claim 1 wherein said data is divided into at least one predetermined amount prior to executing step a), said at least one data structure being sized to accommodate fixed multiples of said predetermined amount.

5. A method according to claim 1 further comprising the steps of:
e) executing an encryption process on said machine for encrypting said compressed data;
f) streaming said compressed data from said compression process to said encryption process; and
g) outputting encrypted data from said encryption process.

6. A method according to claim 1 wherein said compressed data is streamed to an output port of said machine for transmission to a remote machine via a network.

7. A method according to claim 5 wherein said encrypted data is streamed to an output port of said machine for transmission to a remote machine via a network.

8. A method according to claim 1 wherein said physical memory is random access memory.

9. A method for decompressing compressed data in a data processing machine having a physical memory, the method comprising:
a) reading compressed data to be decompressed into a data structure such that said compressed data is stored in said physical memory;
b) executing a decompression process on said machine, said decompression process being for decompressing said compressed data;
c) streaming said compressed data in said physical memory to said decompression process; and
d) outputting decompressed data from said decompression process.

10. A method according to claim 9 wherein said data is completely stored in said physical memory prior to executing step b).

11. A method according to claim 9 wherein said data structure is a byte array.

12. A method according to claim 9 wherein said data is divided into at least one predetermined amount prior to executing step a), said data structure being sized to accommodate fixed multiples of said predetermined amount.

13. A method according to claim 9 further including the steps of:
a1) receiving encrypted and compressed data for decryption and decompression;
a2) storing said encrypted and compressed data in at least one data structure such that said data is stored in said physical memory;
a3) executing a decryption process in said machine, said decryption process being for decrypting said encrypted data;
a4) streaming said encrypted data from said at least one data structure to said decryption process; and
a5) outputting decrypted data from said decryption process,
wherein steps a1)-a5) are executed prior to steps a)-d)

14. A method for processing data in a data processing machine having a physical memory, the method comprising:
a) receiving data for processing;
b) storing said data in at least one data structure such that said data is stored in said physical memory;
c) executing a process on said machine for processing said data;
d) streaming said data from said physical memory to said process initiated in step c); and
e) outputting processed data from said process.

15. A method according to claim 14 wherein said data for processing is completely stored in said physical memory prior to executing step c).

16. A method according to claim 14 wherein said process is chosen from a group comprising:
a compression process;
a decompression process;
an encryption process; and
a decryption process.

17. A method according to claim 14 wherein said data for processing is received from a network interface and said data for processing is compressed data.

18. A method according to claim 14 wherein said processed data is compressed data and said processed data is outputted to a network interface.

19. A method according to claim 14 wherein said data structure is a byte array.

20. A method according to claim 14 wherein said method is embodied in a computer product stored in a computer executable format on a computer readable media.
